(19) United States
(12) Patent Application Publication
(10) Pub. No.: US 2026/0035068 A1
(43) Pub. Date: Feb. 5, 2026

(54) Aircraft Yaw Control System

(71) Applicant: Textron eAviation Inc., Providence, RI (US)

(72) Inventors: Olivier Gougeon, Montreal (CA); Steven G. Hagerott, Wichita, KS (US)

(21) Appl. No.: 18/732,161

(22) Filed: Jun. 3, 2024

Related U.S. Application Data
(60) Provisional application No. 63/506,825, filed on Jun. 7, 2023.

(51) Int. Cl. B64C 29/00; B64D 31/16

(52) U.S. Cl. CPC B64C 29/0033; B64D 31/16

(57) ABSTRACT

An aircraft having a plurality of independent yaw control mechanisms includes an airframe having a central fuselage sized to hold at least one operator or payload and a wing extending from the fuselage. The aircraft includes a distributed thrust array coupled to the airframe, the thrust array having at least a first, second, and third pair of propulsion assemblies. Each propulsion assembly includes a rotor and is operable for at least single-axis thrust vectoring. The aircraft further includes a flight control system operable to independently control and combine each yaw mechanism of the propulsion assemblies. The yaw mechanisms for inducing a yaw moment include: canting at least one pair of propulsion assemblies away from the fuselage, selectively tilting at least one pair of propulsion assemblies forwards and backwards, varying an aerodynamic control surface of at least one propulsion assembly, and varying a rotational speed of at least one propulsion assembly.

### CROSS-REFERENCE TO RELATED APPLICATIONS

This application claims priority to U.S. Provisional Patent Application No. 63/506,825, filed on Jun. 7, 2023, the disclosure of which is incorporated herein in its entirety by reference.

### BACKGROUND

### 1. FIELD

The disclosure relates generally to the field of aircraft flight control systems. More specifically, the disclosure relates to systems and methods for controlling the yaw of aircraft with vertical takeoff and landing (VTOL) capabilities.

### 2. RELATED ART

Various solutions for controlling the yaw of a VTOL aircraft having multiple propulsion assemblies have been proposed. For example, U.S. Pat. No. 10,913,541 to Oldroyd et al. discloses varying the speed of the propulsion assemblies to influence yaw control. U.S. Pat. No. 10,981,661, also to Oldroyd et al. discloses using variable speed control and/or thrust vectoring to control yaw. U.S. Patent No. 11,485,488 to Armer et al. and U.S. Patent Application Publication No. 2013/0105635 to Alzubi et al. each disclose tilting rotors about a single axis or degree of freedom as a means for controlling yaw. U.S. Pat. No. 10,773,802 to Finlay et al. discloses independently tilting rotors forward and backward for controlling yaw.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

According to an embodiment, an aircraft having a plurality of independent yaw control mechanisms includes an airframe having a central fuselage sized to hold at least one operator, a wing extending from the fuselage, first and second longitudinal booms, each being connected to the wing, and a tail wing extending between the first longitudinal boom and the second longitudinal boom. The aircraft is propelled by a two-dimensional distributed thrust array coupled to the airframe, the thrust array comprising at least a first, second, and third pair of propulsion assemblies, each propulsion assembly having a rotor and being operable for at least single-axis thrust vectoring. The aircraft and propulsion assemblies are controlled by a flight control system operable to independently control each of the propulsion assemblies in response to input from an operator. A first yaw mechanism includes inducing a yaw moment by canting at least one pair of propulsion assemblies away from the fuselage, and a second yaw mechanism includes inducing a yaw moment by selectively tilting at least one pair of propulsion assemblies forwards and backwards. A third yaw mechanism includes inducing a yaw moment by varying an aerodynamic control surface of at least one propulsion assembly, and a fourth yaw mechanism includes inducing a yaw moment by varying a rotational speed of at least one propulsion assembly.

According to another embodiment, a flight control system for controlling the yaw moment of a thrust-borne aircraft having a fuselage and a substantially two-dimensional distributed thrust array comprising a plurality of propulsion assemblies is configured to independently control each propulsion assembly in response to an operator input to generate a yaw moment about a center of gravity of the aircraft. This may be achieved by a variety of yaw mechanisms, which may be utilized individually or in combination. These yawing mechanisms include canting one or more propulsion assemblies toward or away from the fuselage, tilting at least one propulsion assembly forward or backward, varying a collective blade pitch of at least one propulsion assembly, and adjusting a rotational speed of at least one propulsion assembly.

### BRIEF DESCRIPTION OF THE DRAWING FIGURES

Illustrative embodiments of the present disclosure are described in detail below with reference to the attached drawing figures, wherein:

FIG. 1 illustrates a top view of a VTOL aircraft having a yaw control system according to an embodiment of the disclosure in a zero-yaw configuration;

FIG. 2 illustrates a top view of a VTOL aircraft having a yaw control system according to an embodiment of the disclosure in a nose-left yaw configuration; and

FIG. 3 illustrates a top view of a VTOL aircraft having a yaw control system according to an embodiment of the disclosure in a nose-right yaw configuration.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

The following embodiments described herein refer to a VTOL aircraft having six independent rotors, although one skilled in the art will appreciate that the features described may be applicable to various configurations of aircraft. For example, some embodiments may utilize more or less than six rotors depending on the specific application and aircraft requirements. Likewise, the disclosure herein is not necessarily limited to VTOL-only aircraft or VTOL-only flight modes. For example, in some embodiments the aircraft may include a plurality of additional flight modes, such as conventional takeoff and landing (CTOL), short takeoff and landing (STOL), and short takeoff and vertical landing (STOVL).

Typically, a VTOL aircraft includes one or more propulsion assemblies (e.g., rotors) which can be controlled or modulated to induce a specific flight behavior. This may be achieved by varying the entire direction of the propulsion assemblies, its rotor speed, or its rotor blades' pitch, such that there is an imbalanced thrust distribution across the aircraft, resulting in a desired change of speed and/or direction. These three independent ways to vary the magnitude and the orientation of each motor thrust vector may be combined together to achieve a desired pitch, roll, or yaw effect on the aircraft's body. Note that as a result of these three independent control mechanisms, the applied torque to the propulsion assemblies may also be varied accordingly in a dependent manner to maintain a particular performance condition, for example. However, existing solutions for controlling the aircraft behavior, with particular attention to yaw control and various types of yaw effectors, have limitations which may be ameliorated by the present disclosure.

Many existing VTOL aircraft utilize a single group of yaw effectors to achieve the desired control, which may prove disadvantageous. For example, simply having a plurality of identical yaw effectors or mechanisms (such as rotor tilting) may not provide sufficient yaw control power and may be unable to produce a desired yawing motion responsively, if at all. Existing yaw control systems and aircraft may also not be capable of supporting an opposite rotor-pair failure without inducing an undesired rotor torque imbalance. Existing solutions for yaw control may require the yaw control to be coupled with other behavior of the aircraft, such as pitch or roll. Instead, it may be advantageous for a yaw control system to be decoupled from or independent of the other axes of flight control. Additionally, it may be advantageous for a yaw control system to include a plurality of different yaw effectors which may work alone or in combination to increase the yaw control capabilities and overall maneuverability, without compromising other flight controls, adding unnecessary weight or drag, and/or increasing the required maintenance and system complexity.

The aircraft and yaw control system described herein may provide multiple overlapping yaw effectors which may provide more precise or accurate control, increased yaw control power, and greater consistency compared to existing solutions without some drawbacks of certain alternative methods for increasing yaw. For example, it may be possible to increase yaw control power by increasing the strength of each propulsion assembly, allowing for higher speeds and/or greater thrust generation. However, increasing the strength and/or size of the propulsion assemblies adds additional weight and aerodynamic drag, which may reduce the range of the aircraft. Another possible strategy for increasing yaw control power may be to increase the maximum tilt angle of the various rotors. However, this may increase complexity and maintenance requirements and also may result in issues with ground clearance in more extreme cases. Alternatively, it may be possible to increase the responsiveness of the aircraft and/or increase yaw control power by increasing the tilt or conversion rate, however this may result in additional dynamic loads (i.e., weight) which decreases other performance capabilities. Yet another possibility would be to add a helicopter-style tail rotor to increase the yaw and have dedicated yaw control rotors, but this would again add unnecessary drag and weight to the craft. The aircraft and yaw control system of the present disclosure seeks to provide similar benefits to these aforementioned ideas, without many of the drawbacks.

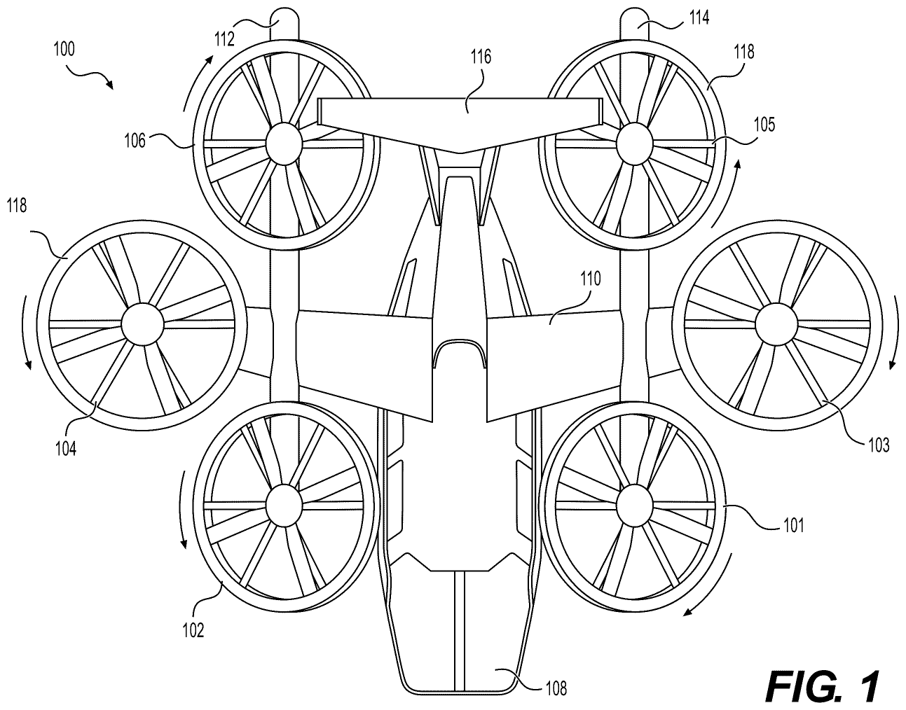

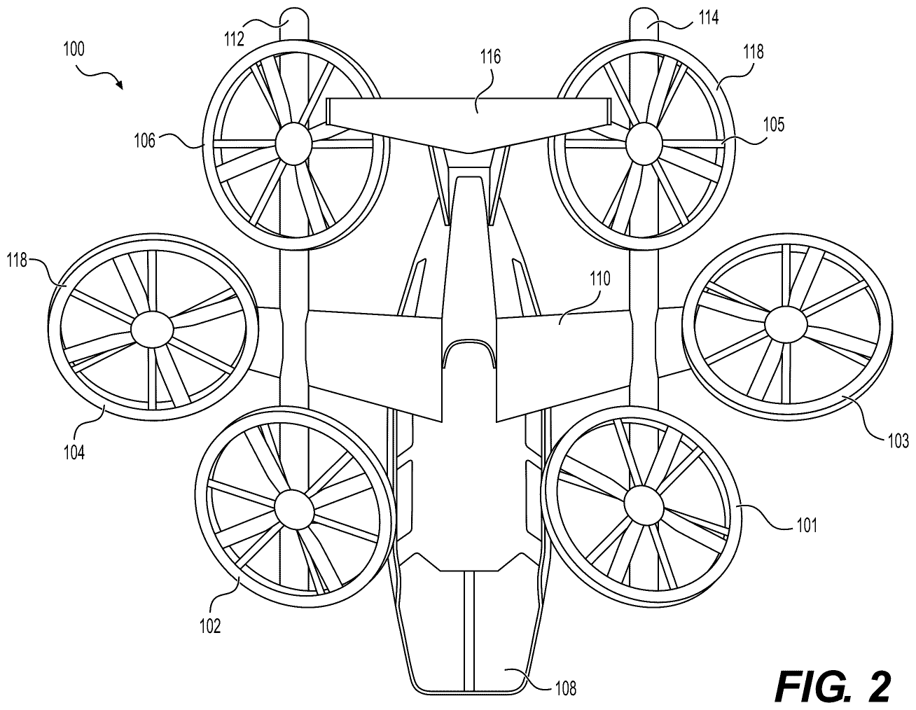

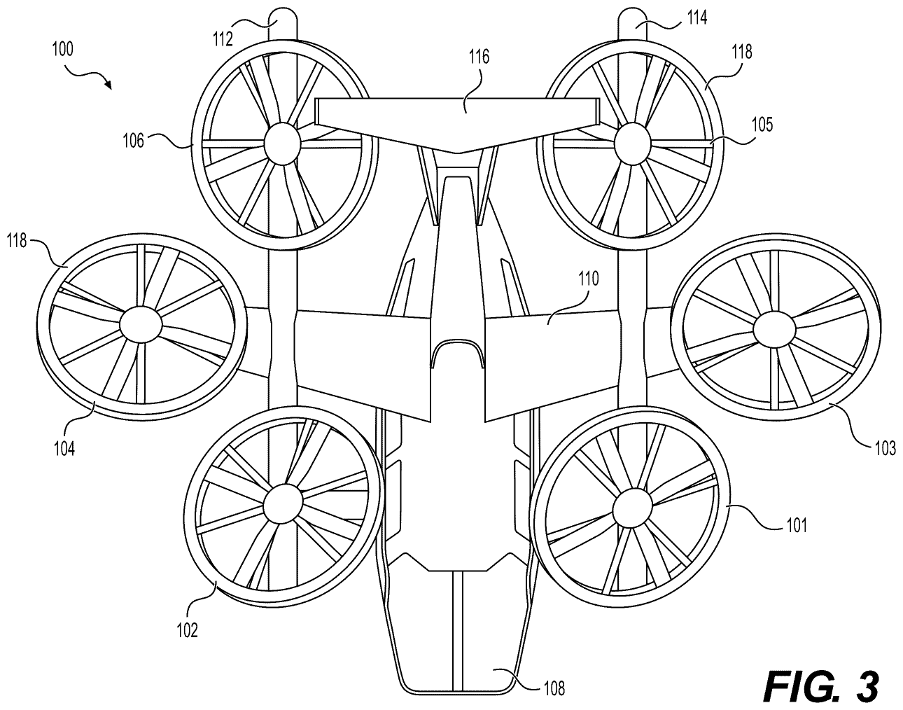

FIGS. 1-3 show a first embodiment of a VTOL aircraft 100 in various yaw configurations; with FIGS. 1 illustrating a zero-yaw configuration, FIG. 2 illustrating a nose-left yaw configuration, and FIG. 3 showing a nose-right yaw configuration. The aircraft 100 generally includes an airframe, an array of six propulsion assemblies in the form of rotors 101-106, and a flight control system configured to operate the propulsion assemblies. The aircraft 100 includes a central fuselage 108 which may be sized to hold at least one passenger and/or pilot, and/or cargo. A wing 110 spans generally the width of the craft and is connected to the fuselage 108. In the illustrated embodiment, the aircraft 100 has two booms 112 and 114, with one being disposed on either side of the fuselage 108, with a tail wing 116 spanning between the first and second booms 112 and 114 at the rear of the aircraft. In some embodiments, a portion of each boom 112 and 114 may be rotatable in order to allow for the aircraft 100 to be operable in other flight modes beyond VTOL, such as wing-borne flight modes. The six propulsion assemblies 101-106 are each mounted to the airframe, and may be mounted in a fixed position or may be dynamically adjustable.

Each of the propulsion assemblies 101-106 includes a propulsion system, which in some embodiments (including the preferred embodiments) is an electric motor having an output drive connected to a rotor assembly comprising a plurality of blades, the rotor assembly being rotatable with the output drive of the electric motor in a rotational plane to generate thrust. The plurality of propulsion assemblies may form a two-dimensional or three-dimensional thrust array. In some embodiments, such as the illustrated embodiment, each of the rotors or propulsion assemblies 101-106 may be contained in a housing or nacelle frame 118. In other embodiments, each propulsion assembly 101-106 may utilize propellers without a surrounding nacelle frame. Each propulsion assembly 101-106 may include a gimbal or similar dynamic mount operable to tilt about a single axis, and in some embodiments, each propulsion assembly 101-106 may include a gimbal or similar dynamic mount operable to tilt about multiple axes. In some embodiments, the aircraft 100 may have a plurality of flight modes, including thrust-borne flight modes (e.g., VTOL) and wing-borne flight modes (e.g., CTOL, STOL, and STOVL).

In the embodiment shown in FIGS. 1-3, the forward rotors 101 and 102 are each mounted to one of the longitudinal booms 112 and 114. In other embodiments, the forward rotors 102 and 104 may be mounted to the fuselage via a lateral support, which in some embodiments may be connected to the nacelle frame 118. The forward left-hand rotor 101 is mounted to a forward portion of the left-hand boom 114, and the forward right-hand rotor 102 is mounted to a forward portion of the right-hand boom 112. As shown in FIG. 1 in the illustrated embodiment, the forward left-hand rotor 101 is driven in the clockwise direction, while the forward right-hand rotor 102 is driven in the counter-clockwise direction. Generally, it may be preferable for the yawing torque produced by the selected direction of rotation of each rotor to coincide with the lever arm moment each rotor generates on the yaw axis, so both effects add up. In other embodiments not shown, the direction and exact location of the rotors may differ, without departing from the scope of the invention.

In some embodiments, such as that shown in FIG. 1, the forward rotors are canted outboard left and right away from the fuselage. The rotors 101 and 102 may be canted at a fixed angle (as in the illustrated embodiment), or may be mounted on a gimbal or other dynamic mount which facilitates a dynamic cant angle. In some embodiments, the cant angle of the forward rotors may be approximately 7 degrees, although in other embodiments this angle may be less than or greater than 7 degrees, depending on application and the requirements of the aircraft.

In addition to being canted outwards, in some embodiments the forward rotors may be mounted on a gimbal or similar pivotable mounting structure to allow the rotors 101 and 102 to be tilted in a desired direction. In the illustrated embodiment, the forward rotors 101 and 102 are selectively pivotable forwards and backwards, in response to commands from a flight control system. In some embodiments, the aircraft 100 may include one or more redundant flight control systems configured similarly to the primary flight control system as an added safety measure. Pivoting the forward rotors 101 and 102 asymmetrically will generate a yawing moment about the center of gravity of the aircraft. For example, as shown in FIG. 3, when the front left-hand rotor 101 is tilted forward and/or the front right rotor 102 is tilted backward this generates an increase in nose-right yawing moment. This is due to the increase of the horizontal thrust component and the lateral lever arm between the front rotor 101 or 102's location and the aircraft's center of gravity. The inverse relationship (left-hand front rotor 101 tilted backward and/or the front right rotor 102 tilted forward), shown in FIG. 2, will generate a nose-left yawing moment. In some embodiments, the rotors 101 and 102 may have a maximum tilt angle of approximately ±10 degrees forwards and backwards relative to a vertical reference when the aircraft operates in VTOL mode, although one of skill will appreciate that in other embodiments the exact range of motion possible may exceed 10 degrees or be less than 10 degrees, without departing from the scope of the invention. In some embodiments, the range of motion of the rotors 101 and 102 may be at least approximately 90 degrees in order to allow the aircraft 100 to operate in a plurality of flight modes.

The middle rotors 103 and 104 are each mounted on the left-hand and right-hand outer edge of the wing 110 respectively. Similar to the rotors 101 and 102, these rotors may be housed in a nacelle frame 118. The middle rotors 103 and 104 may be substantially similar or identical in size and aerodynamic profile to the forward rotors 101 and 102, although in some embodiments they may be smaller than, larger than, or have a different aerodynamic profile compared to the forward rotors. As shown in FIG. 1, in the illustrated embodiment the left-hand middle rotor 103 is driven clockwise, while the right-hand middle rotor 104 is driven in the counter-clockwise direction. Similar to the forward rotors 101 and 102, the direction and exact location of the rotors 103 and 104 may differ in other embodiments not shown, without departing from the scope of the invention.

Like the forward rotors, in some embodiments the middle rotors 103 and 104 may be mounted on a gimbal or similar pivotable mounting structure to allow the rotors to be tilted forwards and backwards, in response to commands from the flight control system. Pivoting the middle rotors 103 and 104 asymmetrically (in conjunction with the forward rotors 101 and 102) will generate a yawing moment about the center of gravity of the aircraft. For example, as shown in FIG. 3, when the middle left-hand rotor 103 is tilted forward and/or the middle right hand rotor 104 is tilted backward this generates an increase in nose-right yawing moment, due to the increase of the horizontal thrust component and the lateral lever arm between the middle rotor 103 or 104's location and the aircraft's center of gravity. The inverse relationship (left-hand middle rotor 103 tilted backward and/or the middle right rotor 104 tilted forward), shown in FIG. 2, will generate a nose-left yawing moment. In some embodiments, the rotors 103 and 104 may have a maximum tilt angle of approximately ±8 degrees forwards and backwards relative to a vertical reference when the aircraft operates in VTOL mode, although one of skill will appreciate that in other embodiments the exact range of motion possible may exceed 8 degrees or be less than 8 degrees, without departing from the scope of the invention.

The rear rotors 105 and 106 are mounted on the left-hand and right-hand booms 114 and 112 respectively, and are located aft of the wing 110. In some embodiments, the rear rotors may be driven in the opposite direction to the middle and forward rotors which are on the same side of the fuselage 108. For example, in the illustrated configuration, the left-hand rear rotor 105 is driven in the counterclockwise direction, while the right-hand rear rotor 106 is driven in the clockwise direction. Similar to the front rotors 101 and 102, the rear rotors 105 and 106 may be canted away from the fuselage. The rotors 105 and 106 may be canted at a fixed angle (as in the illustrated embodiment), or may be mounted on a gimbal or other dynamic mount which facilitates a dynamic outboard cant angle. In embodiments where the rotors are canted at a fixed angle, the rear rotors 105 and 106 may be canted at a substantially similar angle to the forward rotors 101 and 102. In some embodiments, the cant angle of the rear rotors may be approximately 7 degrees, although in other embodiments this angle may be less than or greater than 7 degrees, depending on application and the requirements of the aircraft.

The configuration of the various propulsion assemblies 101-106 in conjunction with the flight control system provide various yaw effectors. These can be broken down into two main categories: thrust vectoring or conversion effectors, and thrust modulation or yaw delta thrust (YDT) effectors. The thrust vectoring or conversion yaw effectors typically include tilting or canting one or more rotors asymmetrically, or more generally varying the direction of the thrust vector for one or more propulsion assemblies. The YDT effectors may include utilizing asymmetrical and/or variable rotor speeds across the array of propulsion assemblies, as well as asymmetrical changes in the collective blade pitch (CBP) across the various rotors, or more generally, altering the magnitude of the thrust generated at individual propulsion assemblies. Torque modulation can also be applied on top of thrust modulation to maintain the propulsion assemblies in a desired operating regime, such as varying the torque as a function of CBP changes to maintain a constant motor RPM.

Canting the forward and aft rotors 101, 102, 105, and 106 outboard creates a yaw effector that works by generating differential thrust and torque values between the four canted rotors, although there can be a tradeoff in overall horizontal (i.e., forward and backward) thrust capabilities. These thrust and torque differences, herein referred to as yaw delta thrust commands (YDT commands), can be generated either via delta CBP (collective blade pitch) or RPM (rotation per minute) commands applied to the forward and aft rotors. By canting the rotors, a new component of the thrust vector is introduced, where a portion of the thrust is directed laterally as well as vertically. This lateral thrust vector component, in tandem with the lever arm between the propulsion assembly and the center of gravity, creates a yawing moment. For example, a nose-left yawing moment is generated when the front left rotor 101 is canted outboard and the thrust is increased for this rotor (for example, by increasing the RPM or the CBP). The “opposite” rotor about the aircraft's center of gravity, the right rear rotor 106, can also generate a nose-left yawing moment when it is canted outboard and thrust is increased. Similarly, a nose-right yawing moment can be generated by increasing the thrust generated by the forward right-hand rotor 102 and the aft left-hand rotor 105 when either or both are canted outboard. Thrust can also be decreased to produce the opposite motions just introduced.

As noted above, the cant angle may be fixed or static (such as the illustrated embodiment), or it may be dynamic and variable. This may be achieved similarly to the forwards and backwards tilt ability of the forward and middle rotors 101-104, e.g., by a gimbal or similar pivotable dynamic mount which operably rotates the propulsion assemblies towards or away from the centerline of the aircraft 100. In embodiments wherein the cant angle is dynamically modulated, this may be controlled by the flight control system in response to inputs by the pilot or by a command given to the flight control system in embodiments wherein the aircraft 100 is autonomously operated. Although in the illustrated embodiment, the rotors are canted outboard at a fixed angle e.g., approximately 7 degrees, in other embodiments it may be desirable for the canted rotors to be canted inboard or at another angle greater than or less than 7 degrees in magnitude.

In the illustrated embodiment, the middle rotors 103 and 104 are not canted, as there is a negligible lever arm with which to generate an effective yawing moment. However, in other embodiments where there may be a non-negligible lever arm between the middle rotors 103 and 104 and the vehicle's center of gravity, the middle rotors 103 and 104 may be canted similar to the forward and aft rotors 101, 102, 105, and 106. Likewise, in embodiments with other than six rotors various propulsion assemblies or pairs of propulsion assemblies may be canted at a fixed or variable angle, without departing from the scope of the invention.

Similar to canting, as previously noted a yawing moment can be created by tilting one or more of the propulsion assemblies 101-106 forwards or backwards. In the illustrated embodiment, this specifically refers to the forward and middle rotors 101-104, although in other embodiments not shown this may be applied to the aft rotors or indeed any number of rotors in embodiments with other than six rotors as illustrated in FIGS. 1-3. In the illustrated embodiment, the forward rotors 101 and 102 may tilt between ±10 degrees, while the middle rotors 103 and 104 have a maximum tilt of ±8 degrees, although in other embodiments each of these limits may vary without departing from the scope of the invention. Tilting the rotors creates a yawing moment in much the same as canting the rotors-by creating an additional thrust component separated from the vehicles center of gravity by a lever arm-and typically includes modulating the thrust generated by one or more of the tilted rotors in some way. For example, as seen in FIG. 3, a nose-left moment can be generated by tilting at least one of the front-right and middle-right rotors 102 and 104 forwards, or more specifically more forwards than rotors 101 and 103. This relationship is true in reverse to generate a nose-right moment as well as shown in FIG. 2. This effect can be combined with thrust modulation (such as varying the speed or CBP of one or more rotors) to create a more consistent and predictable yaw effector.

The conversion or tilting rate may be controlled or limited by the flight control system, and may have a notable effect on the consistency of the yawing moment and the performance of the aircraft itself. In the illustrated embodiment, the forward and middle rotors 101-104 have a conversion rate of approximately 10 degrees per second in both directions, although in some other embodiments the conversion rate may vary depending on a number of factors. It may be disadvantageous to significantly increase the conversion rates, as doing so may add undesired dynamic loads.

In addition to the conversion effectors, the YDT commands can also generate a significant yawing moment. This can primarily be achieved in two ways; varying the speed of one or more rotors, or by varying the collective blade pitch in combination with the motor torque to modulate the thrust generated at a constant motor speed. While both of these achieve generally the same effect, they may be used in differing conditions or applications, based on different optimization criteria proper to each flight phase, for example thrust-borne versus wing-borne. Compared to speed variation, changing the CBP (and torque to maintain constant speed) is generally more responsive and therefore can increase the general maneuverability of the aircraft, and is adequately suited for high bandwidth tasks. RPM modulation, while slower, may be generally more suited for low bandwidth tasks, such as combatting the effects of crosswinds and for trimming the aircraft in any given flight mode.

The YDT commands or effectors can be combined with the conversion effectors to generate complex and/or consistent yaw moments compared to existing solutions. For example, to create a nose-right moment, this can be achieved by any combination of tilting the front-left rotor 101 forwards, tilting the front-right rotor 102 backwards, tilting the middle-left rotor 103 forwards, tilting the middle-right rotor 104 backwards, decreasing the collective blade pitch (CBP) of the front-left rotor 101, increasing the CBP of the front-right rotor 102, increasing the CBP of the left aft rotor 105, and decreasing the CBP of the right aft rotor 106.

When a pilot or operator desires to generate a yawing moment via yaw control inceptor (e.g., pedals located in the cockpit), each of the yaw effectors disclosed above may be utilized to deliver the required output. Preferably, the flight control system independently controls each of the rotors in order to generate the desired effect, thereby creating a more consistent yawing moment and to prevent the various yaw effectors from working against each other. Consistently utilizing each independent yaw effector may also safeguard against latent failures in various components.

Providing multiple independent but overlapping yaw effectors can prove beneficial even in the event of a rotor failure, where a failure in one propulsion assembly 101-106 allows for the flight control system to adjust another propulsion assembly 101-106 to maintain a consistent or constant yaw moment. For example, if a failure occurs within the front left rotor 101, the aft right rotor 106 may be consequently adjusted by the flight control system to mitigate the effects of the failure and maintain safe flight conditions. Likewise, if a failure occurs within the front right rotor 102, the aft left rotor 105 may be consequently adjusted by the flight control system.

Although the invention has been described with reference to the embodiments shown in the attached drawing figures, it is noted that the equivalents may be employed and substitutions made herein without departing from the scope of the invention as recited in the claims.

Having thus described various embodiments of the invention, what is claimed as new and desired to be protected by Letters Patent includes the following:

What is claimed is:

1. An aircraft having a plurality of independent yaw control mechanisms, the aircraft comprising:
an airframe having a central fuselage sized to hold at least one operator or payload and a wing extending from the fuselage;
a two-dimensional distributed thrust array coupled to the airframe, the thrust array comprising at least a first, second, and third pair of propulsion assemblies, each propulsion assembly having a rotor and being operable for at least single-axis thrust vectoring; and
a flight control system operable to independently control and combine each yaw mechanism of the propulsion assemblies;
wherein:
a first yaw mechanism includes inducing a yaw moment by canting at least one pair of propulsion assemblies away from the fuselage;
a second yaw mechanism includes inducing a yaw moment by selectively tilting at least one pair of propulsion assemblies forwards and backwards;
a third yaw mechanism includes inducing a yaw moment by varying a collective blade pitch of at least one propulsion assembly; and
a fourth yaw mechanism includes inducing a yaw moment by varying a rotational speed of at least one propulsion assembly.

2. The aircraft of claim 1, wherein third yaw mechanism includes varying a motor torque to maintain a constant motor rotational speed.

3. The aircraft of claim 1, wherein the aircraft has a plurality of flight modes including a thrust-borne flight mode and a wing-borne flight mode.

4. The aircraft of claim 1, wherein at least one pair of propulsion assemblies includes a gimbal mount and is operable for at least dual-axis thrust vectoring.

5. The aircraft of claim 4, wherein the first yaw mechanism includes dynamically canting at least one pair of propulsion assemblies in response to a command from the flight control system.

6. The aircraft of claim 4, wherein the first, second, and third pair of propulsion assemblies is a forward, middle, and aft pair of propulsion assemblies, respectively, and the second yaw mechanism includes tilting at least one of the forward pair of propulsion assemblies and the middle pair of propulsion assemblies.

7. The aircraft of claim 6, wherein the aircraft has a plurality of flight modes including a thrust-borne flight mode and a wing-borne flight mode, and wherein a maximum tilt of the forward pair of propulsion assemblies and the middle pair of propulsion assemblies each exceeds 90 degrees.

8. The aircraft of claim 1, further comprising:
first and second longitudinal booms, each boom being connected to the wing and being disposed on either side of the fuselage; and
a tail wing extending between the first longitudinal boom and the second longitudinal boom.

9. The aircraft of claim 1, wherein the first, second, and third pair of propulsion assemblies is a forward, middle, and aft pair of propulsion assemblies, respectively, and the first yaw mechanism includes canting the forward pair of propulsion assemblies and the aft pair of propulsion assemblies away from the fuselage at a fixed angle.

10. The aircraft of claim 1, wherein the flight control system is configured to implement a yaw mechanism of a first propulsion assembly in response to a fault detected in a second propulsion assembly.

11. The aircraft of claim 1, wherein the flight control system further comprises a redundant flight control system.

12. A flight control system for controlling the yaw moment of a thrust-borne aircraft having a fuselage and a substantially two-dimensional distributed thrust array comprising a plurality of propulsion assemblies, the flight control system being configured to independently control each propulsion assembly in response to an operator input to generate a yaw moment about a center of gravity of the aircraft utilizing a yaw mechanism, wherein the yaw mechanisms include:
canting one or more propulsion assemblies toward or away from the fuselage;
tilting at least one propulsion assembly forward or backward; and
adjusting a rotational speed of at least one propulsion assembly.

13. The control system of claim 12, wherein in response to a failure in a first propulsion assembly, the flight control system automatically adjusts a second propulsion assembly that is symmetrically disposed about the center of gravity of the aircraft relative to the first propulsion assembly to maintain a constant yaw moment.

14. The control system of claim 12, wherein the yaw mechanisms further include varying a collective blade pitch of at least one propulsion assembly.

15. The control system of claim 14, wherein the flight control system is further configured to vary a motor torque and maintain a constant motor rotational speed of a propulsion assembly when varying the collective blade pitch of said propulsion assembly.
